(19) United States
(12) Patent Application Publication
(10) Pub. No.: US 2002/0161624 A1
(43) Pub. Date: Oct. 31, 2002

(54) Decision support for automated power trading

(76) Inventor: Robert S. Bradlee, Virginia Beach, VA (US)

Correspondence Address: Lance L. Vietzke, Dorsey & Whitney LLP, Republic Plaza Building, Suite 4700, 370 Seventeenth Street, Denver, CO, 80202-5647, US

(21) Appl. No.: 10/061,659

(22) Filed: Feb. 1, 2002

Related U.S. Application Data
(60) Provisional application No. 60/268,877, filed on Feb. 16, 2001.

(51) Int. Cl. G06F 17/60

(52) U.S. Cl. 705/10

(57) ABSTRACT

A system for providing power trading recommendations and forecasting. The system receives plant data relating to various physical parameters from power generating plants, and it also receives market-related data from various sources providing information relating to a market condition for power consumption. The system uses heuristic, neural network, or artificial intelligence techniques to process the plant and market-related data according to business rules. Based upon the processing, the system can provide to users recommendations and forecasting concerning power trading. The system can also provide visual displays of the plant and market-related data on maps. A local application on the user-side can monitor for communication failures based upon interaction with the system.

### REFERENCE TO RELATED APPLICATION

The present application is a continuation-in-part of U.S. Provisional Patent Application Serial No. 60/268,877, entitled “Decision Support for Automated Power Trading,” and filed Feb. 16, 2001, incorporated herein by reference as if fully set forth.

### FIELD OF THE INVENTION

The present invention relates to a system and method that provides decision support and forecasting for one or more of the following: the bidding, sale, and contracting of electrical power generation; the bidding, purchase, and contracting of fuel supplies for conversion to electrical power; or the monitoring of emissions, and the bidding and trading of emission credits associated with the generation of electric power.

### BACKGROUND OF THE INVENTION

The passage of the Public Utility Regulatory Policies Act of 1978 (PURPA) and the Energy Policy Act of 1992 (EPACT) paved the way for the transformation of the electric power industry by effectively eliminating barriers to a competitive marketplace. Implementation of de-regulated electricity markets gave rise to an organization called the Independent System Operator (ISO) whose primary purpose is to identify the demand for electrical power in their regional market, and control the bidding, contracting, and costs of electricity in their region. The ISO uses real-time, near-term, and long-term needs of the market to forecast electricity demands.

The demand for power is satisfied through the use of power purchase agreements with Independent Power Producers (IPPs). The ISO uses a commodity-style marketplace in which the supply/demand relationship for power dictates price. As power requirements increase, the ISO must anticipate this need early and contract for additional generation. If the ISO fails to promptly identify increasing power requirements, prices tend to rise. The further forward the ISO can establish market needs, the more flexibility he or she has to contract power at reasonable prices. Probably the most significant impact of the power purchasing function is meeting the changing needs of real-time demand, referred to as the spot market.

In contrast with the ISO is the IPP who owns and/or operates electrical generation facilities that supply power to a grid through contracts with the ISO. In many ways the ISO and IPP have mutual goals. Both desire long-term stable agreements that provide electrical power for consumption by end users. However, their mutual goals may start to diverge as power is purchased close to its delivery. Since electrical power cannot be easily stored but must be consumed as it is generated, a certain amount of volatility is expected in these short-term markets.

The IPP must consider a wide range of factors in pricing the generation of electrical power, especially in the spot market. The key factors that influence pricing are the following: (1) availability, meaning the IPP must determine if sufficient generating assets are available to meet demand requirements; (2) efficiency of the specific plant equipment that will be used to generate electricity must be known and factored into pricing; (3) the IPP must purchase fuel (gas, coal, and oil) to convert into electricity, and an adequate supply of fuel must be available and its price known prior to executing a power contract; and (4) each generating plant is limited in the amount of environmental emissions it is allowed to release into the atmosphere, and if a plant has insufficient emission credits on deposit, it must buy credits from other plants or suffer steep penalties.

Another leg of the de-regulated power generation market is the market maker or exchange. Each regional ISO is associated with an exchange that utilizes financial instruments to offset the risk of power trading similar to other commodities markets. Since electricity cannot be easily stored, brokers of electricity cannot close their positions on power contracts. The board of directors of an IPP has a legal obligation to exercise its duties of care and responsibilities by prudently hedging the volumetric risk associated when generating power in a de-regulated market. The function of the exchange is to allow companies to mitigate their risk by using forward pricing contracts, options (puts/calls), collars, and other commodity-style financial instruments. These instruments allow the IPP to hedge its risk of failure to deliver or forced delivery under economically disadvantageous terms.

### SUMMARY OF THE INVENTION

A method and system consistent with the present invention provide decision support for automated power trading. Data is acquired from power generating plants relating to available power for distribution, and data is gathered from a plurality of sources for factors relating to a market condition for power consumption. The acquired data is combined with the gathered data, and the combined data is processed in order to provide recommendations concerning distribution of the available power based upon the market condition. The method and system can optionally provide for display of the data merged with map data providing for indications of plant and market conditions with geographical references.

Another method and an apparatus consistent with the present invention locally monitor a remote service. Upon detecting a local communication failure, local and remote resources are checked, and the method and apparatus attempt to resolve the communication failure based upon the checking of the local and remote resources.

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram of a system for decision support for automated power trading and related processes;

FIG. 2 is a flow chart of a plant sub-system method;

FIG. 3 is a flow chart of a market sub-system method;

FIG. 4 is a flow chart of a central repository method;

FIG. 5 is a diagram illustrating display of power data with map data;

FIG. 6 is a flow chart of a map display method;

FIGS. 7A-7H are exemplary screens for the map display method; and

FIG. 8 is a flow chart of local system monitor method.

### DETAILED DESCRIPTION

Overview

Embodiments of the present invention include a system that aids in the determination of suitability of entering into contracts for the generation of electricity by integrating a wide variety of disparate data into a comprehensive information set that can be used to determine when, where, and how to generate electrical power.

The system acquires data from individual power generating plants in the form of process signals, computed data, and inference information. Examples of process signals include pressures, temperatures, flows, rates, and other parameters. Examples of computed data include heat rate, efficiency, machine state, and deviations from normal. Examples of inference information include conclusions of an intelligent agent. These data types can be displayed to local plant operators as well as being transmitted to a central repository, which may be in close physical proximity to the generating plant or remote from it. Transmission of the data types can occur through common carrier or private carrier transmission networks. The system combines data from each of one or more generating plants at a central repository, allows the cross-unit analysis of generating plants, and provides for storage of each of the generating plant's data in a relational database, for example, using a common format.

The system also acquires data from various outside entities such as, but not limited to, market demand and rates, generation requirements and forecasts, demand pricing, weather, generation control conditions, base point, fuel pricing and availability, limits and schedules, and other information as may be needed to assess market conditions. The market conditions include any aspect or information concerning the market that may be useful as a consideration for power trading and forecasting. These data are acquired via communications networks such as, for example, the World Wide Web, the Internet, a public switched telephone network, and/or private leased-lines.

The system integrates data transmitted from each of the generating plants with information retrieved from outside sources within, for example, a single comprehensive relational database structure or other data structure. This data is operable by, for example, asset managers for power trading, fuel purchase, emissions trading, performance, reliability and condition health engineering, and financial divisions within a single operating entity.

The system can use conventional web browser software to retrieve and display information to appropriate functional divisions of the entity. Protocols such as, but not limited to, HyperText Markup Language (HTML), Extensible Markup Language (XML), ActiveX, tables, views, and other graphical user elements can be used in the delivery of information to appropriate individuals.

The system can use an artificial intelligence engine or other heuristic-type techniques to implement business rules as a support mechanism to users. Series and schema of rules can be built that serve as either manually initiated or automatically triggered rule sets to provide decision support information to appropriate personnel based upon application of the rules to the acquired data.

An exemplary system includes four parts: a plant sub-system located at or in communication with each generating site; a market sub-system that retrieves information from outside sources; a central repository sub-system located at a central site which contains data from the plant and market sub-systems; and a web sub-system that provides user display and interface services. Taken together, these four sub-systems combine to provide a fully interactive decision support system for an IPP. The four sub-systems can alternatively be combined into fewer sub-systems or distributed across more sub-systems.

Power Trading System

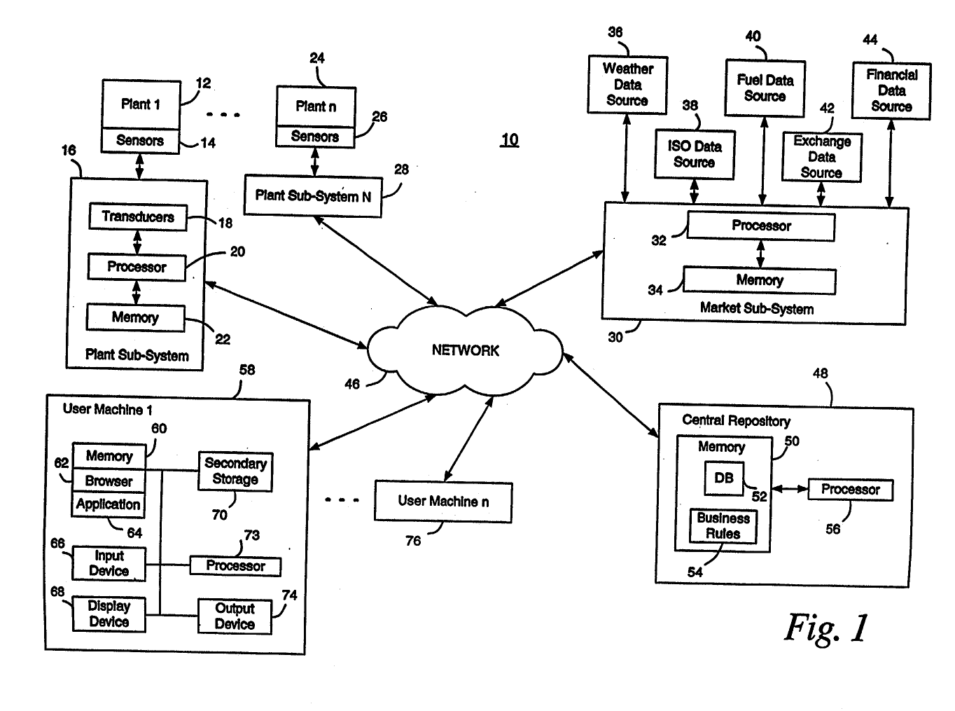

FIG. 1 is a diagram of a system 10 for decision support for automated power trading, forecasting, and related processes. System 10 includes one or more plant sub-systems 16 and 28 that receive and process data from power generating plants 12 and 24. Each of the plants 12 and 24 typically includes sensors 14 and 26, respectively, for conversion of physical parameters relating to the plant operations into corresponding electrical signals. Plant sub-system 16 can include transducers 18 for providing conversion of signals from sensors 14 into digital signals. A processor 20 receives the digital signals representing plant data from plant 12 and provides for processing of the data as explained below. Plant sub-system 16 can also include a memory 22 for storing data and applications for execution by processor 20. Plant sub-system 28 can include, for example, the same components as plant sub-system 16. A plant sub-system can be located physically at a plant or remote from a plant and in communication with it via a network.

A market sub-system 30 can include a processor 32 and a memory 34 for storing data and applications for execution by processor 32. Market sub-system 30 receives and processes market-related data, which includes any information related to a market condition concerning possible power consumption for use in decision support for power trading and forecasting. All of the exemplary data sources or databases are accessible via known communications networks. For each of the data sources, processor 32 in the market sub-system can contact those sources over a network such as the networks identified above and download the data using conventional Internet protocol or other communication protocols.

For example, the market sub-system can receive weather data from a weather data source 36; ISO data from an ISO data source 38; fuel data from a fuel data source 40; exchange data from an exchange data source 42; financial data from a financial data source 44; and possibly data from other sources. Weather data source 36 can include any database accessible via a network and providing information concerning current and past weather conditions for particular geographical regions. ISO data source 38 can include a database accessible via a network and providing the information maintained by the ISO as described above. Fuel data source 40 can include a database accessible by a network and providing information concerning the availability of fuel for power generation. Exchange data source 42 can include a database accessible via a network and providing the information maintained by the exchange as described above. Financial data source 44 can include any database accessible via a network and providing information concerning availability and use of financial instruments for power trading. In addition to or in place of these exemplary data sources, other types of data sources or databases, private or public, may also be used to obtain market-related data.

A central repository 48 receives power data from the plant sub-systems 16 and 28, and receives market-related data from market sub-system 30. Central repository 48 can receive the data via a network 46, such as the Internet or a conventional telephone network, using conventional communication protocols. Central repository 48 can include a memory 50 for storing a database 52 of the plant and market-related data and a plurality of business rules 54 for use in processing the data. A processor 56 can provide processing of the data based upon the business rules 54, as explained below, and integration of plant and market-related data into data sets for processing through application of the business rules. An exemplary implementation of database 52 is provided in the U.S. provisional application identified above.

Central repository 48 can transmit, via network 46, decision support for power trading and forecasting information to one or more users at user machines 58 and 76. User machine 58 illustrates exemplary components of a user machine for receiving and displaying information for decision support for power trading and forecasting from central repository 48. User machine 58 can include a memory 60 for storing a web browser 62 and other applications 64; an input device 66 for receiving information or commands; a display device 68 for providing a visual display of information; a secondary storage device 70 for providing non-volatile storage of data; a processor 72 for executing browser 62 and other applications 64; and an output device 74 for providing various types of outputs such as a printer for hard copies of information or speakers for audio information. User machine 76 can include, for example, the same components as user machine 58. A user machine can alternatively include any processor-based device for receiving information via a network and displaying it in pages or screens.

Power Trading Methods

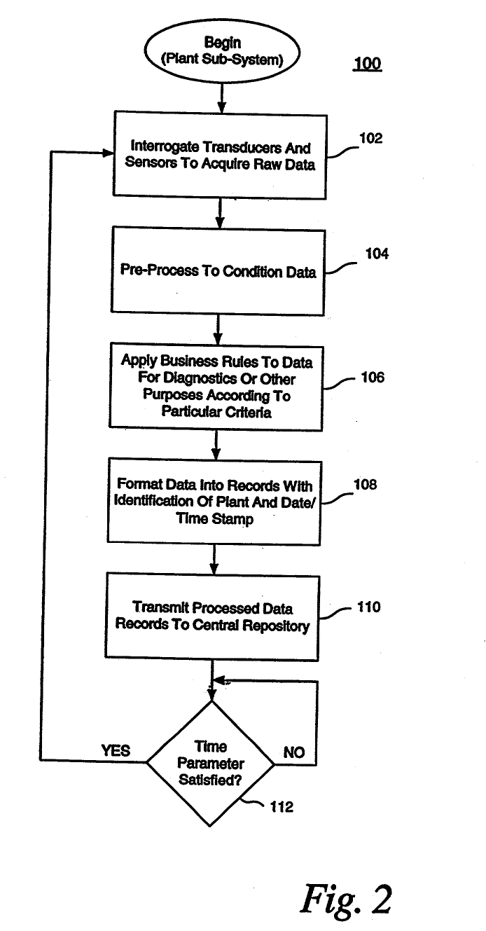

FIG. 2 is a flow chart of a plant sub-system method 100. Method 100 may be implemented in, for example, software modules for execution by processor 20 in plant sub-system 16. Each plant sub-system 16 and 28 can include its own local software modules for executing method 100. In method 100, the plant sub-system can interrogate transducers 18 and sensors 14 to acquire raw data from plant 12 (step 102). The data can include, for example, information for the following parameters from the plant: a pressure value, a temperature value, a flow value, and a rate value. It can also include, for example, the following types of computed data: a heat rate, an efficiency, a machine state, and deviations from normal. The computed data results from mathematical processing of the raw data from the plant according to particular criteria.

The plant sub-system can pre-process the data to condition it (step 104). Conditioning of data may occur, for example, to place various types of disparate data in a common format and possibly to weight the data for application of business rules and heuristic processing. The plant sub-system can locally apply business rules to the data for diagnostics or other purposes according to particular criteria (step 106). Various techniques for processing data according to business rules are provided below.

After processing the data, the plant sub-system formats the processed data into records, associating the data with an identification of the corresponding plant and possibly a date/time stamp (step 108). Table 1 provides an example of a data structure for storing the records of plant data associated with the corresponding power plants and date/time stamps. The parameter value in Table 1 can specify, for example, the type of plant data such as a temperature or pressure parameter. The plant identifier (ID) can be specified in a separate field in the event that, for example, one plant sub-system obtains data from multiple plants. If one plant sub-system only obtains data from one plant, then the same plant ID can be associated with each record. The plant ID can include any information to identify a plant such as a name, address, or geographical coordinates.

TABLE 1

| record | plant | data parameter | date/time stamp | plant data |
|---|---|---|---|---|
| 1 | plant ID 1 | parameter 1 | date 1/time 1 | data 1 |
| 2 | plant ID 1 | parameter 2 | date 2/time 2 | data 2 |
| 3 | plant ID 2 | parameter 3 | date 3/time 3 | data 3 |
| . . . | | | | |
| N | plant ID N | parameter N | date N/time N | data N |

The plant sub-system transmits the data records to central repository 48 via network 46 (step 110). The plant sub-system can repeatedly cycle through the method based upon a time parameter, for example, or other criteria. For example, it may repeat the process upon expiration of a timer or at particular times throughout each day. Therefore, the plant sub-system can determine whether a time parameter is satisfied (step 112) and, if so, repeat the method.

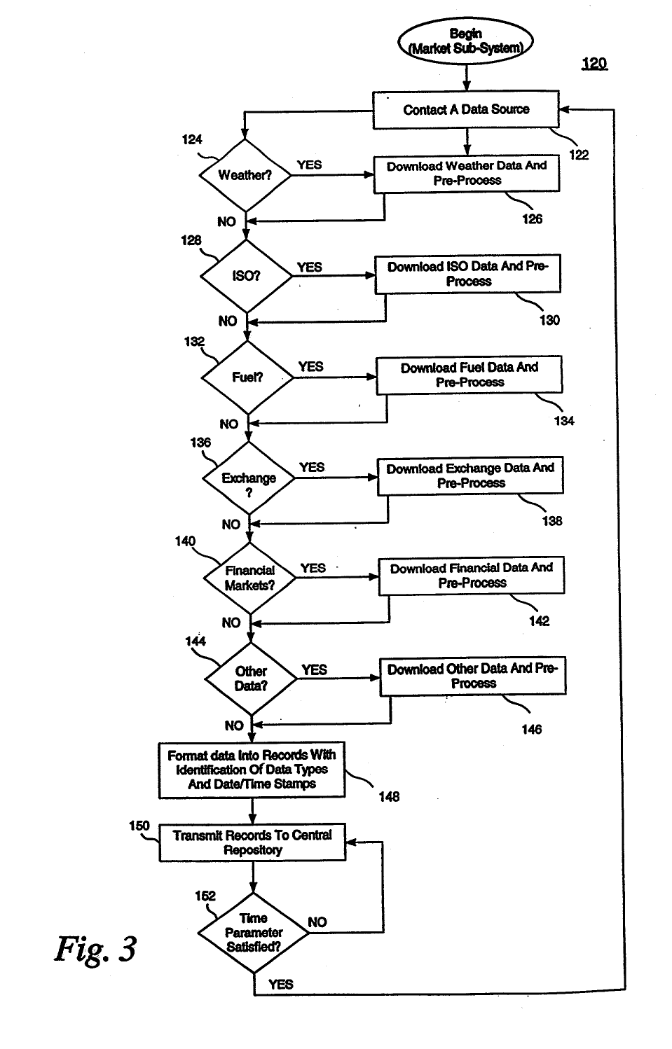

FIG. 3 is a flow chart of a market sub-system method 120. Method 120 may be implemented in, for example, software modules for execution by processor 32 in market sub-system 30. System 10 may optionally include a plurality of market sub-systems for gathering market-related data, in which case each market sub-system can locally execute software modules to implement method 120. In method 120, the market sub-system contacts a data source via network 46 such as the Internet or a conventional telephone network (step 122). The market sub-system can be programmed to contact particular data sources in any particular order and may possibly contact only a sub-set of the data sources upon each cycle through method 120.

For each data source contacted, the market sub-system downloads and pre-processes the data from the data source. The pre-processing can occur, for example, to place the data into a common format for processing as it may be downloaded from a variety of sources having data in disparate formats. The market-related data from the various sources above can include, for example, data related to the following factors: market demand, market rates, generation requirements, generation forecasts, demand pricing, weather, generation control conditions, base point, fuel pricing, fuel availability, and limits and schedules.

If weather data source 36 is contacted (step 124), the market sub-system downloads and pre-processes weather data (step 126). If ISO data source 38 is contacted (step 128), the market sub-system downloads and pre-processes ISO data (step 130). If fuel data source 40 is contacted (step 132), the market sub-system downloads and pre-processes fuel data (step 134). If exchange data source 42 is contacted (step 136), the market sub-system downloads and pre-processes exchange data (step 138). If financial data source 44 is contacted (step 140), the market sub-system downloads and pre-processes financial data (step 142). If another type of data source is contacted (step 144), the market sub-system downloads and pre-processes the other type of market-related data (step 146).

Each data source typically has a database accessible via a network such as network 46. The market sub-system can maintain a table or other structure containing an Internet Protocol (IP) or network address for each source in order to contact it via the network along with a protocol, if required, for downloading data from the data source. For example, if the data is in HTML form, the market sub-system can download it using conventional browser technology and Internet communication protocols. If the data is in other formats, the market sub-system may need to know the type of format for use in downloading and interpreting the data. Table 2 illustrates a data structure for storing this type of information.

TABLE 2

| Data Source | Network Address | Data Format or Protocol |
|---|---|---|
| weather | address 1 | protocol 1 |
| ISO | address 2 | protocol 2 |
| fuel | address 3 | protocol 3 |
| exchange | address 4 | protocol 4 |
| financial | address 5 | protocol 5 |
| . . . | | |
| source N | address N | protocol N |

After downloading and pre-processing the various types of data, the market sub-system formats the data into records for subsequent processing according to business rules (step 148). The pre-processing can include, for example, converting disparate data types into a common data format, converting non-numerical data into numerical data, and generating structured data sets for neural network or heuristic processing as described below. The market sub-system also typically provides an identification of the data source for each data type, if not apparent from the data, and a date/time stamp for each piece of data (step 148). The identification of the data source and date/time stamps can be used for heuristic processing in order to, for example, weight particular data types to emphasize that type of data in providing decision support.

Table 3 illustrates a data structure for storing records for this type of information. The data source ID can include any information to identify the source of the data; for example, for weather data the source ID may provide the geographical location of the corresponding weather conditions, and for the fuel data the source ID provide the geographical location of the available fuel.

TABLE 3

| record | data source ID | data type | date/time stamp | converted data |
|---|---|---|---|---|
| 1 | source ID 1 | weather | date 1/time 1 | data 1 |
| 2 | source ID 2 | ISO | date 2/time 2 | data 2 |
| 3 | source ID 3 | fuel | date 3/time 3 | data 3 |
| 4 | source ID 4 | exchange | date 4/time 4 | data 4 |
| 5 | source ID 5 | financial | date 5/time 5 | data 5 |
| . . . | | | | |
| N | source ID N | data type N | date N/time N | data N |

The market sub-system transmits the records to central repository 48 via network 46. The market sub-system can be programmed to contact the various data sources according to a time parameter such as expiration of a timer or at particular times of each day. Therefore, it can determine whether a time parameter is satisfied (step 152) and, if so, repeat method 120.

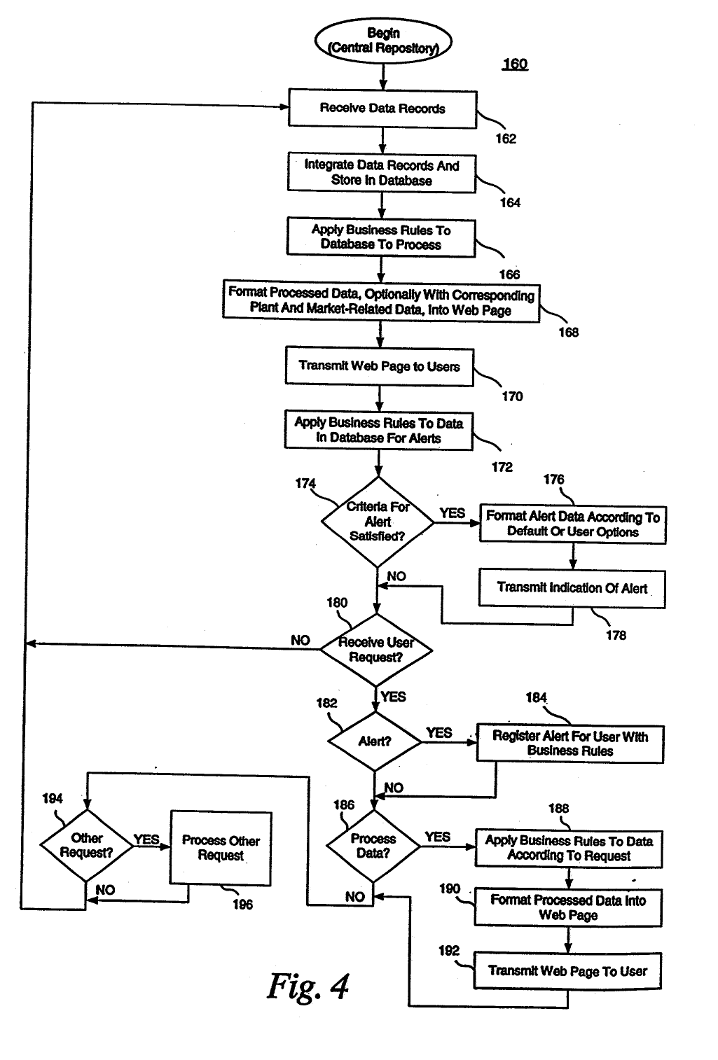

FIG. 4 is a flow chart of a central repository method 160. Method 160 can be implemented in, for example, software modules for execution by processor 56 in central repository 48. In method 160, central repository 48 receives data records from the plant and market sub-systems via network 46 (step 162). Central repository 48 integrates the data records from the plant sub-systems 16 and 28 and the market sub-system 30, and stores them in database 52 in memory 50 (step 164). Integration of the data means that the various disparate types of data are converted into data sets having a common format for storage in a data structure and later retrieval for processing.

Memory 50 can be implemented with a non-volatile data storage with a sufficient capacity to maintain the various records in a data structure such as tables or objects. The plant and market-related data in database 52 is processed according to particular business rules by processor 56 (step 166).

Various methodologies exist for accomplishing the application of the business rules to the plant and market-related data for step 166. This processing can result in the recommendations for power trading, information for power forecasting, or to run simulations based upon entered hypothetical data or modifications to actual data. For example, an empirical method may be used that generates the power trading recommendations and forecasting based upon a trial-and-error approach. This method may use, for example, a baseline set of plant and market-related data along with an initial set of default business rules. The rules can then be empirically refined based upon the accuracy of the power trading recommendations and forecasting and a determination of which rules result in greater or lesser success in following the recommendations or in the accuracy of the power forecasting.

Another exemplary method can use neural network processing techniques with optional weighted variables. For this method, the business rules can be represented by mathematical formulas to process variables, the values of which are derived from the plant data and the market-related data. Each variable can also be optionally weighted to further refine the processing. For example, it may be known, such as via empirical techniques, that particular variables are more important for reliability and accuracy of the power trading recommendations and forecasting, and those variables can be weighted appropriately in order to emphasize them. A neural network software or hardware implementation can process the variables to generate information for the power trading recommendations and forecasting.

The neural network can include, for example, pre-processors to condition or weight the variables in addition conversion of raw data from the plant and market sub-systems into suitable variable data for processing. A neural network to generate the information for power trading recommendations and forecasting can be implemented with a conventional neural network for processing data; neural networks and technology, including structuring of raw data into data sets for processing, are known in the art as described, for example, in the following text, incorporated herein by reference: Timothy Masters, “Practical Neural Network Recipes in C++,” pp. 253-341 (Morgan Kaufmann 1993). Examples of neural network products include the following: the BrainMaker Neural Network Software Product by California Scientific Software, Nevada City, Calif.; and the NeuroSolutions product and related products by NeuroDimension, Inc., Gainesville, Fla.

Another exemplary method may involve an algorithmic approach as follows. The business rules can be translated into algorithms, and the data from the plant and market sub-systems can be converted into a common format in data sets. A software program implementing the algorithms, possibly using artificial intelligence techniques, can then process the data sets to generate the information for power trading recommendations and forecasting.

Based upon any of the above exemplary techniques or other techniques, the processing results in recommendations concerning power trading or forecasting, or in other outputs. The processing can include, for example, recommendations concerning use of particular financial instruments for distribution of at least a portion of the available power, including recommendations for use of one or more of the following: forward pricing contracts, options, and collars.

Central repository 48 formats the processed data, optionally with the corresponding plant and market-related data, into one or more web pages or screens for display (step 168). It transmits the web pages to one or more user machines 58 and 76 via network 46 (step 170). An exemplary implementation of a screen to display power data and possibly power trading recommendations is provided in the U.S. provisional application identified above.

As an alternative to web pages, screens or any other display format can be used. Central repository 48 can store an identification of user's or user machines, such as an IP address, in order to transmit the web pages to those users on-line. The users can then view the data in the web pages via browser 62.

Central repository 48 can also apply the business rules to data in database 52 for processing alerts (step 172). An alert can constitute a message concerning the recommendations transmitted in approximate real-time, meaning that the message is transmitted in close time proximity to the occurrence of the events resulting in the corresponding plant and market-related data. The message can include, for example, a visual message displayed to the user via a browser or audio messages provided to the user via the user machine.

Central repository 48 determines whether criteria for an alert is satisfied (step 174) and, if satisfied, it can format data for the alert according to default or user options (step 176). Central repository 48 transmits an indication of the alert to a corresponding user (step 178). The alert can be transmitted in a variety of ways such as in an e-mail message or via a pop-up icon or window on the user's display device. Table 4 provides an exemplary data structure for storing alert information. Each alert can be represented by one or more rules such that, when the rule is satisfied based upon application of plant and market-related data to it, an alert is triggered.

TABLE 4

| user | user's network or e-mail address | user's alert |
|---|---|---|
| user 1 ID | user 1 address | rule(s) for alert 1 |
| user 2 ID | user 2 address | rule(s) for alert 2 |
| . . . | | |
| user N ID | user N address | rule(s) for alert N |

Central repository 48 determines whether it received a user request (step 180). If it received a request for an alert (step 182), it registers the alert for the user with corresponding business rules (step 184), as illustrated in Table 4. If it received a request to process data (step 186), it processes the request using applicable business rules. Central repository 48 applies business rules to data in database 52 according to the request (step 188), formats the processed data into a web page or screen (step 190), and transmits the web page to the user (step 192). Central repository 48 can also be programmed to process other types of requests and, upon receiving such a request (step 194), it processes the request (step 196) according to the programming for it.

Display of Power and Market-Related Data with Map Data

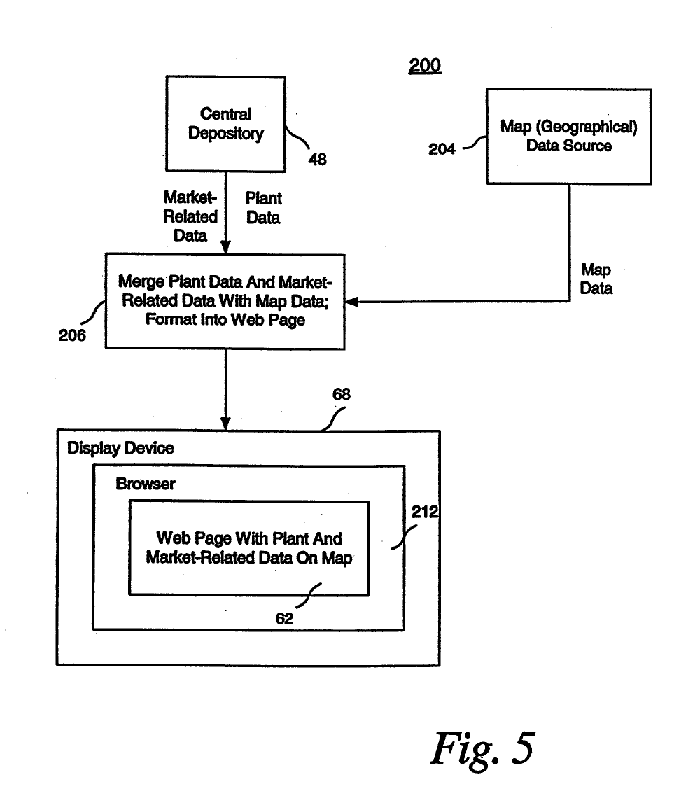

FIG. 5 is a diagram illustrating a system 200 for display of power data with map data. A sub-system 206 receives plant data and market-related data from central repository 48 and map data from a map (geographical) data source 204. It merges the plant and market-related data with the map data and formats the merged data into a web page or screen 212 for display. The web page 212 can then be displayed to the user on display device 68 using browser 62. Sub-system 206 can be implemented, for example, by processor 56 executing an application to merge the data as described below.

Map data source 204 can be implemented, for example, by data stored in memory 50. Map data can include any visual representation of geographical references. The plants can each be associated with a particular geographical location, such as latitude and longitude coordinates, in order to determine a location on the displayed map to identify each plant and the corresponding plant data. The map can thus provide an easy and convenient way for a user to view plant data and market-related data for plants by presenting it in a geographical context.

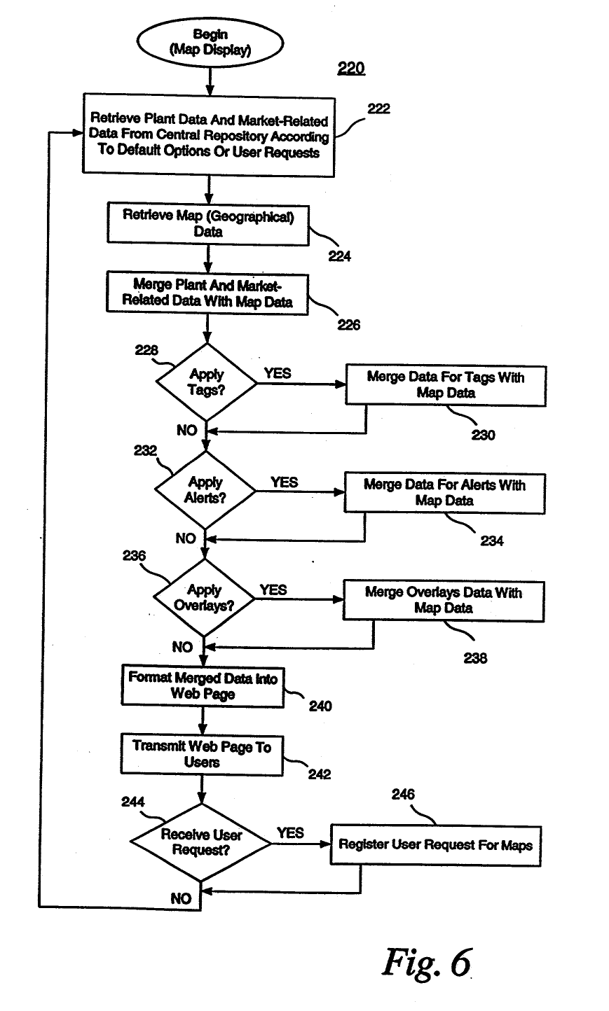

FIG. 6 is a flow chart of a map display method 220. Method 220 can be implemented in, for example, software modules for execution by sub-system 206. In method 220, the sub-system receives plant data and market-related data from central repository 48 according to default options or user requests (step 222). It also retrieves map data from map data source 204 (step 224). The sub-system merges the plant and market-related data with the map data (step 226). Alternatively, the sub-system can merge only plant data, or only market-related data, with the map data.

Each plant, and hence each piece of plant data, can be associated with geographical coordinates. Likewise, market-related data, where relevant, can be associated with geographical coordinates. For example, weather data can be associated with the particular geographical region for the corresponding weather conditions. Table 5 illustrates an exemplary data structure for associating plant and market-related data, where relevant, with geographical data and possibly other relevant information.

TABLE 5

| data type | date/time stamp | geographical coordinates | data |
|---|---|---|---|
| plant 1 | date 1/time 1 | coordinates 1 | data 1 |
| plant 2 | date 2/time 2 | coordinates 2 | data 2 |
| market-related data | date 3/time 3 | coordinates 3 | data 3 |
| . . . | | | |
| data type N | date N/time N | coordinates N | data N |

As illustrated in Table 5, each piece of data can be associated with a data type and a date/time stamp for use in merging it with the map data. For example, various types of icons or other visual display elements can be used for particular types of data. The date/time stamps can be used, for example, to indicate on the merged map display when the data was acquired.

The sub-system also performs processing to determine whether to include tags, alerts, and overlays on the display. If the display includes tags (step 228), the sub-system merges data for the tags with the plant, market-related, and map data (step 230). If the display includes alerts (step 232), the sub-system merges data for the alerts with the plant, market-related, and map data (step 234). If the display includes overlays (step 236), the sub-system merges overlays data with the plant, market-related, and map data (step 238). Tags include user-defined or default “hot-spots” on a map, representing physical entities such as power plants, ISO regions, or others. Alerts include the messages concerning particular conditions as described above. Overlays include any type of geographically-related information overlaid on the map such as latitude/longitude lines and time zones for display. The tags, alerts, and overlays can be included based upon, for example, user-defined or default options.

The sub-system formats all of the merged data into a web page or screen (step 240) and transmits the web page to particular user machines for display to the users via a browser (step 242).

The sub-system also determines whether it receives a user request (step 244) and, if so, it registers the user request for a particular map display (step 246). Table 6 illustrates a data structure for storing users' requests and the rules for them. The rules can specify, for example, what the corresponding user desires on a map display, such as tags, alerts, and overlays.

TABLE 6

| user | user's network or e-mail address | user's alert |
|---|---|---|
| user 1 ID | user 1 address | rule(s) for request 1 |
| user 2 ID | user 2 address | rule(s) for request 2 |
| . . . | | |
| user N ID | user N address | rule(s) for request N |

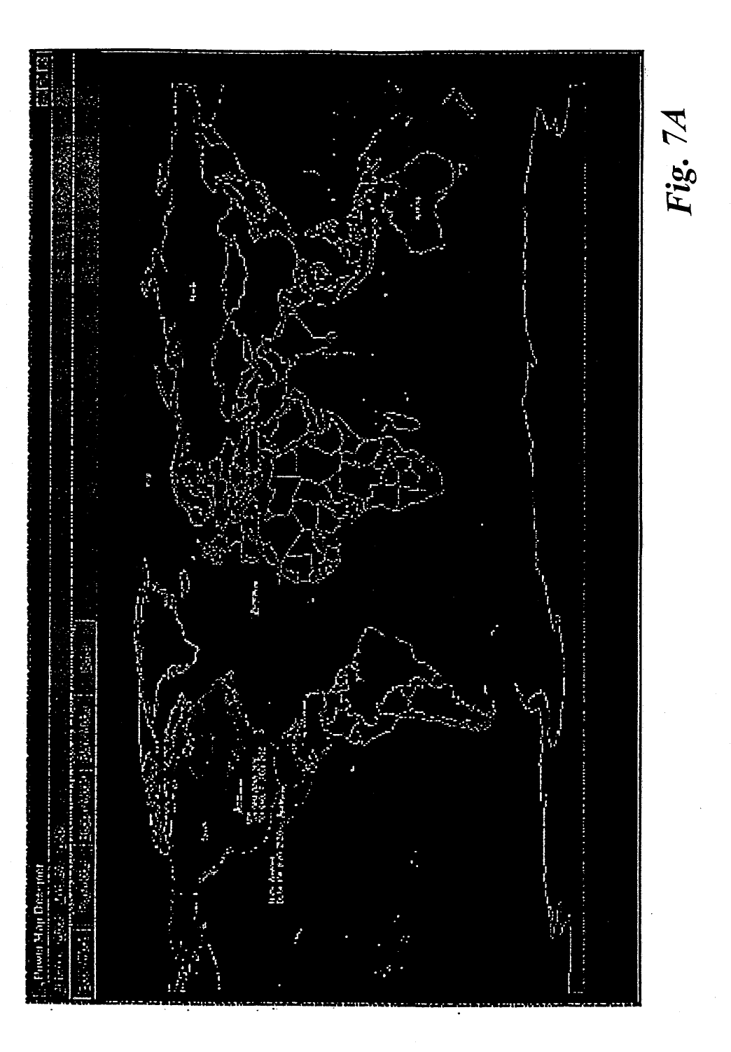

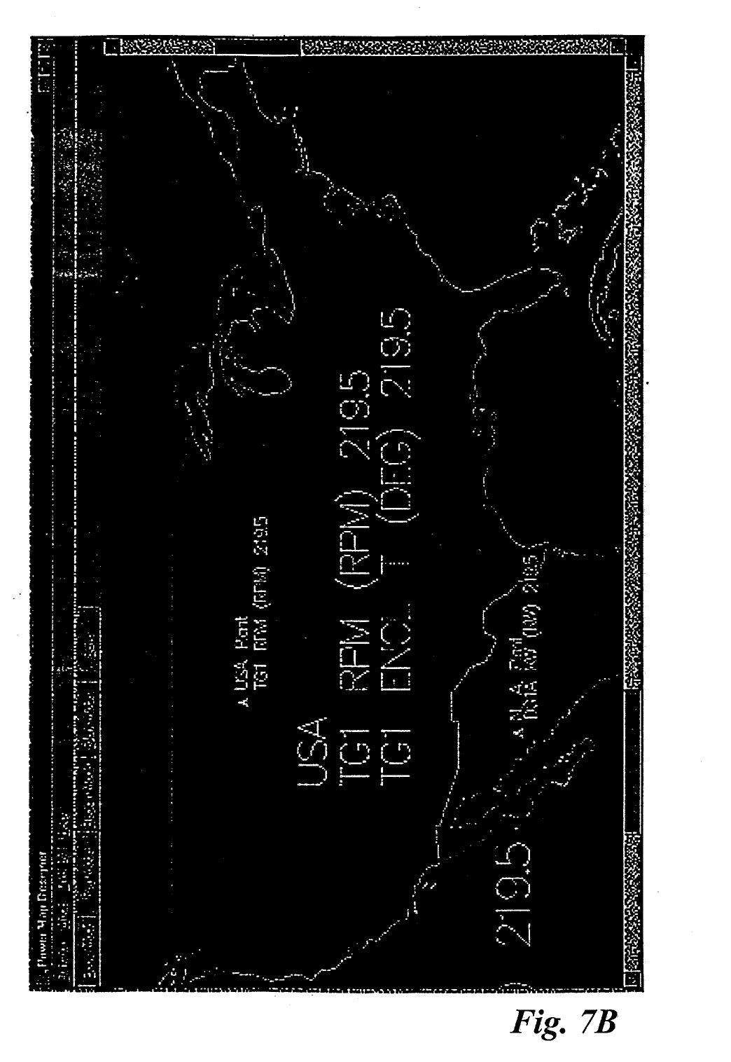

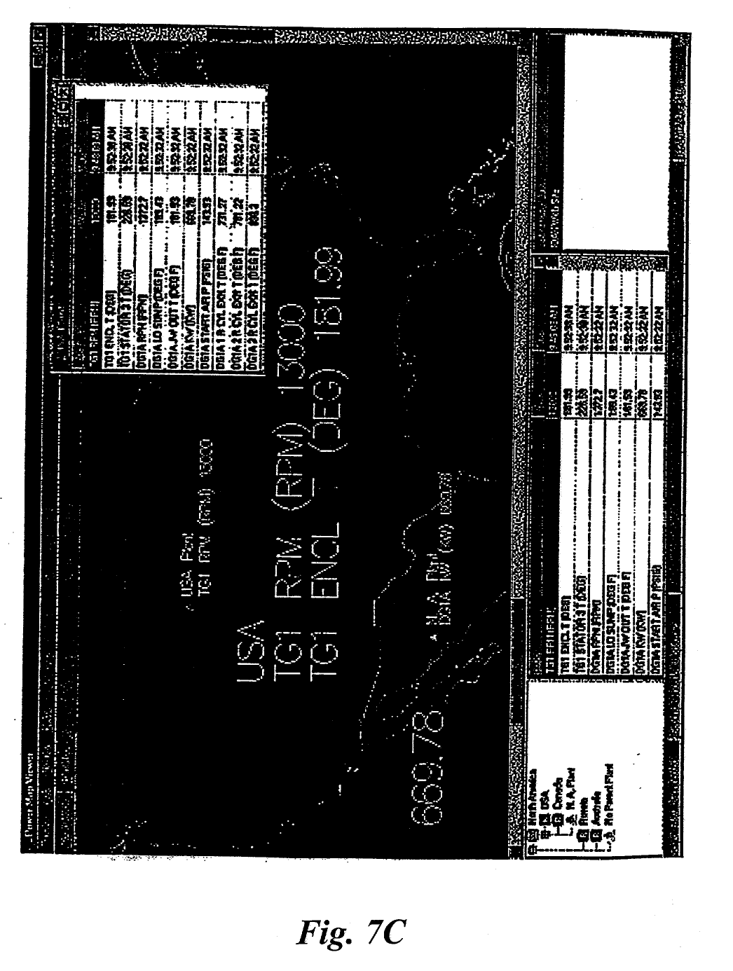

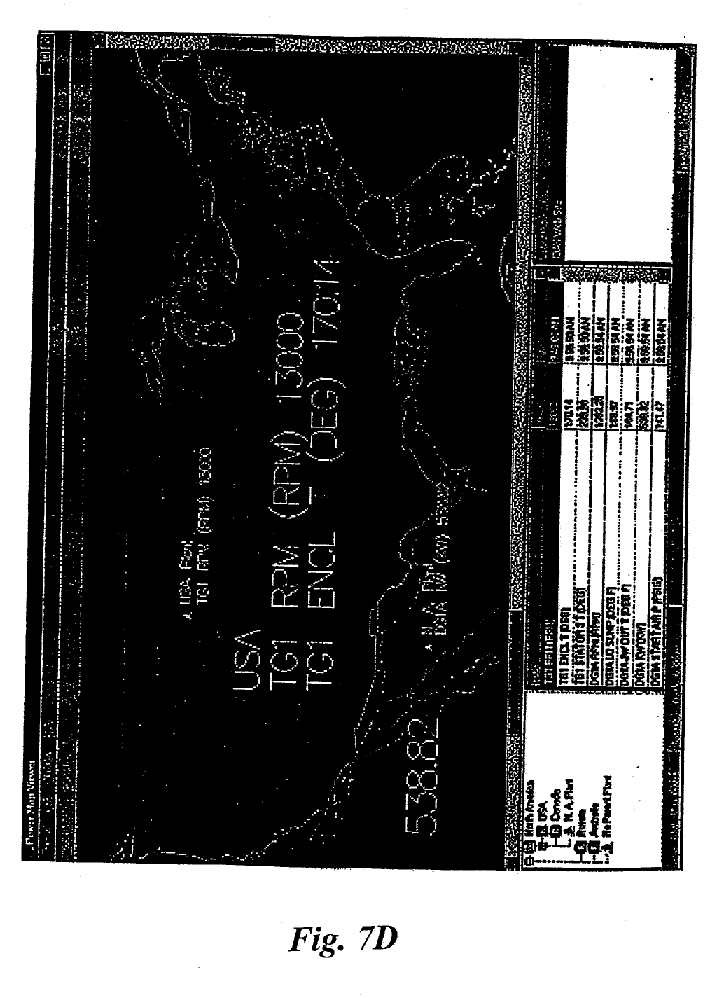

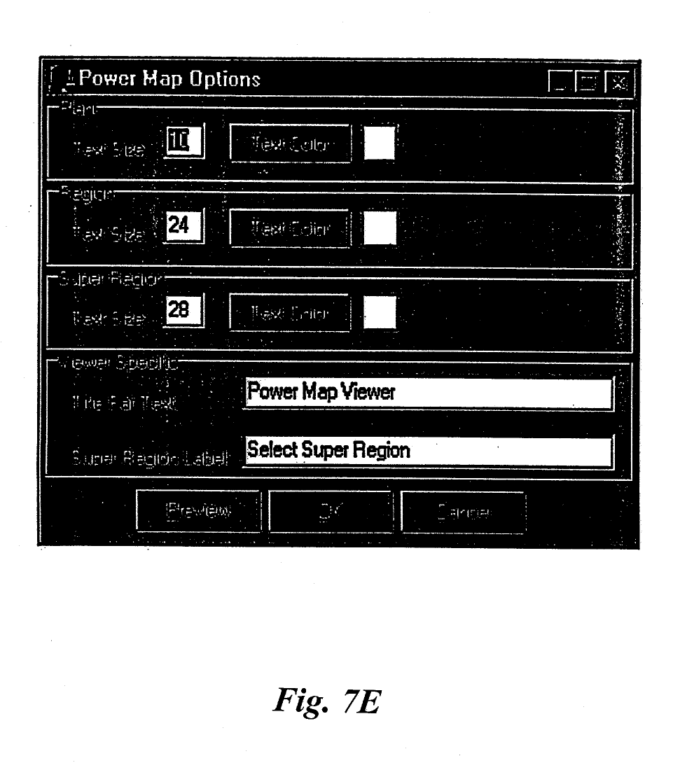

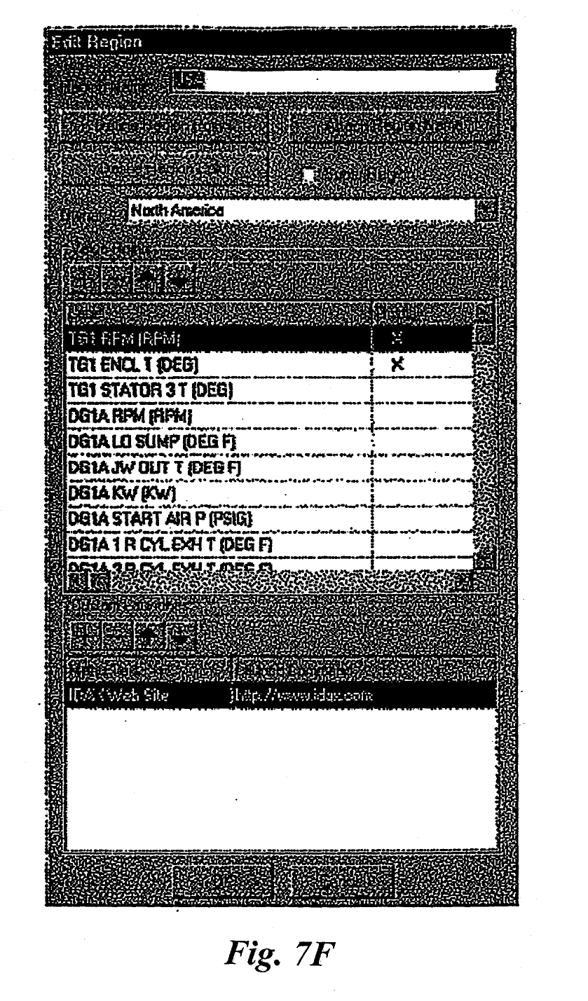

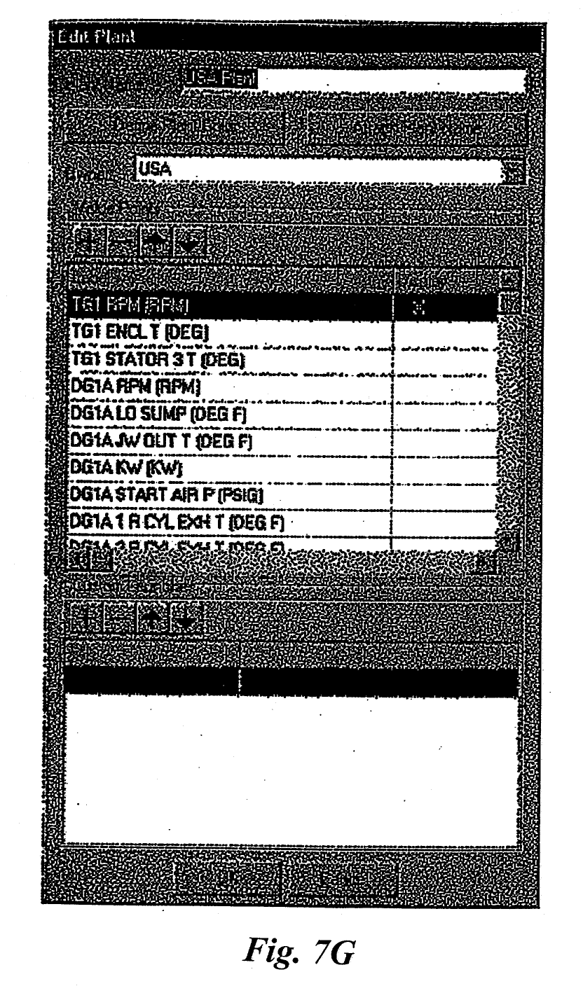

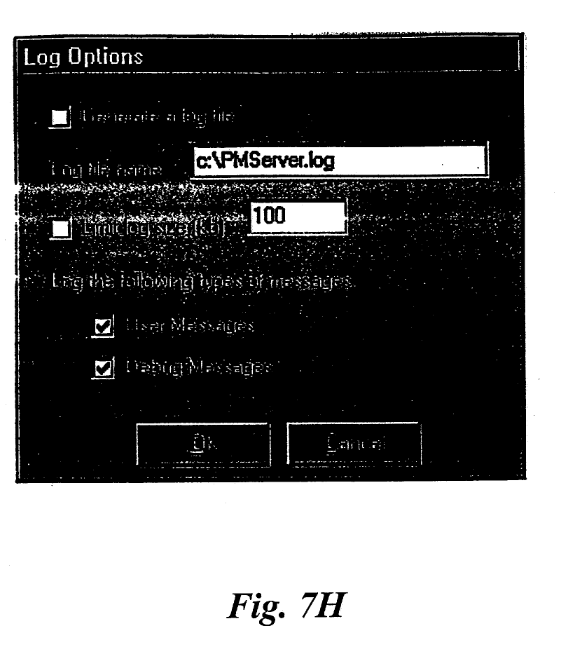

FIGS. 7A-7H are exemplary screens illustrating display of data for method 220. These screens can be formatted in, for example, web pages for display by display device 68 using browser 62. FIG. 7A illustrates an example of a general layout of geographical references for display of power and market-related data. FIG. 7B illustrates an enlarged portion of the screen in FIG. 7A showing exemplary plant data as associated with a plant indicated by the triangle icon. FIG. 7C illustrates an inset section on the screen of FIG. 7A, and an additional section beneath the geographical references, showing the logging of plant data for the plant as indicated by the triangle icon. The displayed logging of data can potentially occur in real-time or near real-time; in particular, central repository 48 can transmit the data to the user machine upon receiving it from the plant and market sub-systems as described above. FIG. 7D screen illustrates an exemplary overlay on the screen of FIG. 7A showing state boundaries and names for the displayed map of the United States.

FIG. 7E illustrates an exemplary section for a user to enter options for the displayed data such as text size and color options for displayed indications of plants, regions, and super regions, and options for display of title bar text and a super region label. FIG. 7F illustrates an exemplary section for a user to edit properties for a displayed region. FIG. 7G illustrates an exemplary section for a user to edit properties for a displayed indication of a plant. FIG. 7H illustrates an exemplary section for a user to enter options for the displayed log as illustrated in the screen of FIG. 7C.

The data and formatting shown in the screens of FIGS. 7A-7H are shown for illustrative purposes only, and different formatting and data can be used.

Local System Monitor Method

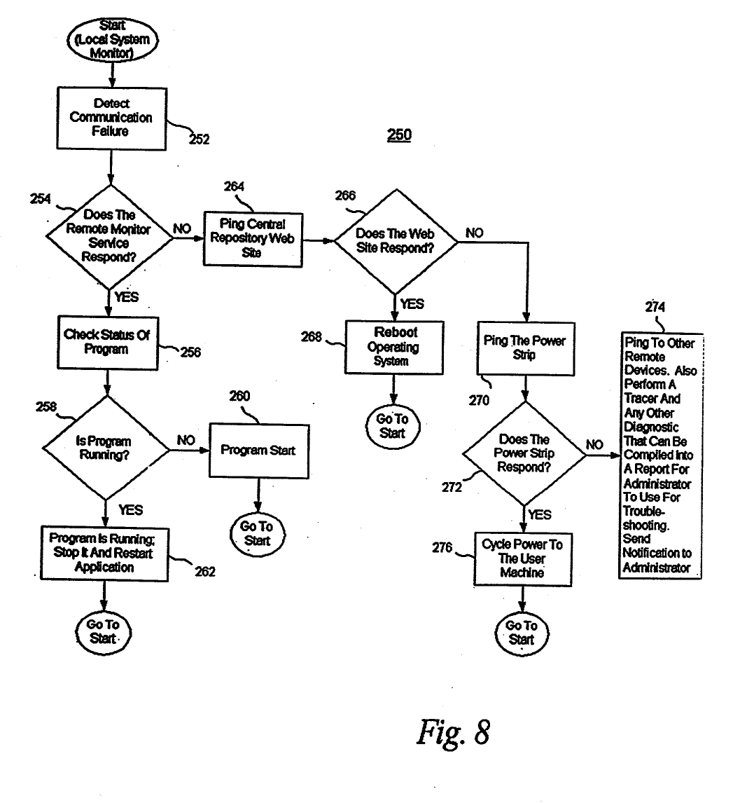

FIG. 8 is a flow chart of a local system monitor method 250. Method 250 can be implemented in, for example, software modules as represented by application 64 for execution by processor 72. Method 250 can be used to locally monitor user machine 58 while on-line and receiving data from central repository 48 via network 46, as well as possibly monitoring other local processes. In method 250, the local application is invoked by detecting a communication failure (step 252). The local application determines whether the remote monitor service responds, in this exemplary implementation central repository 48 (step 254). If the remote service does respond, the local application checks the status of a local program, such as a browser or other application, in user machine 58 for communication with the service (step 256). If the program is not running (step 258), the local application starts or otherwise launches the program (step 260). If the program is running (step 258), the local application stops and subsequently restarts or otherwise relaunches the program (step 262).

Returning to step 254, if the remote service did not respond, the local application pings the central repository 48 web site (step 264) and determines if it responds (step 266). A “ping” can occur via an attempt to contact a remote site or device with a request for a responsive communication. If the web site does respond (step 266), the local application reboots the operating system for user machine 58 on which it is running (step 268). If the web site did not respond (step 266), the local application pings the power strip for user machine 58 on which it is running (step 270) and determines if the power strip responds (step 272). If the power strip does respond (step 272), the local application cycles power to user machine 58 (step 276). Otherwise, if the power strip did not respond (step 272), the local application pings other remote devices; it can also perform a tracer and possibly other diagnostics that can be compiled into a report for an administrator or other person to use for troubleshooting, and it sends the report to the administrator via network 46 (step 274).

Table 7 illustrates an exemplary record for the report. The machine ID can specify for the administrator information identifying the machine experiencing a communication failure, and the user ID can specify, if applicable, information identifying the current user at the machine. The error log or message can constitute, for example, a text string or message indicating the various communication or other failures that occurred in the execution of method 250.

TABLE 7
Troubleshooting Report

| | | |
|---|---|---|
| machine ID | user ID | error log or message |

For each of the Tables 1-7, the records can be stored in any order and the orders shown are provided for exemplary purposes only. Also, each data structure may include additional or different fields depending upon a particular implementation, and they can be stored in any type of database.

While the present invention has been described in connection with an exemplary embodiment, it will be understood that many modifications will be readily apparent to those skilled in the art, and this application is intended to cover any adaptations or variations thereof. For example, various types of user devices, hardware components for the devices, types of network transmissions, and processing to apply business rules to data may be used without departing from the scope of the invention. This invention should be limited only by the claims and equivalents thereof.

What is claimed is:

1. A method for providing decision support for automated power trading, comprising:
acquiring data from power generating plants relating to available power for distribution;
gathering data from a plurality of sources for factors relating to a market condition for power consumption;
combining the data from the power generating plants with the data from the plurality of sources; and
processing the combined data in order to provide recommendations concerning distribution of the available power based upon the market condition.

2. The method of claim 1 wherein the acquiring data step includes acquiring process signals for the power generating plants including one or more of the following: a pressure value, a temperature value, a flow value, and a rate value.

3. The method of claim 1 wherein the acquiring data step includes acquiring computed data for the power generating plants including one or more of the following: a heat rate, an efficiency, a machine state, and deviations from normal.

4. The method of claim 1, further including providing for display the acquired data from the power generating plants.

5. The method of claim 1, further including transmitting the acquired data from the power generating plants to a central repository.

6. The method of claim 1 wherein the gathering data step includes obtaining information relating to one or more of the following factors: market demand, market rates, generation requirements, generation forecasts, demand pricing, weather, generation control conditions, base point, fuel pricing, fuel availability, and limits and schedules.

7. The method of claim 1, further including converting the gathered data and the acquired data to a common format and storing the formatted data in a data structure.

8. The method of claim 1 wherein the processing step includes:
retrieving rules relating to power forecasting; and
applying the rules to the combined data in order to generate the recommendations.

9. The method of claim 1 wherein the processing step includes providing recommendations concerning use of particular financial instruments for distribution of at least a portion of the available power.

10. The method of claim 9 wherein the providing step includes providing the recommendations for use of one or more of the following: forward pricing contracts, options, and collars.

11. The method of claim 1 wherein the processing step includes providing for display, in approximate real-time, a message concerning the recommendations.

12. The method of claim 1, further comprising merging the data from the power generating plants with map data providing geographical references and transmitting the merged data for display.

13. The method of claim 12 wherein the merging step includes merging data for one or more of the following with the merged data: tags, alerts, and overlays.

14. A method for providing geographical references for display of plant data, comprising:
acquiring data from power generating plants relating to available power for distribution;
gathering data from a plurality of sources for factors relating to a market condition for power consumption;
retrieving map data relating to a geographical location of the power generating plants;
merging the acquired data and the gathered data with the map data; and
transmitting the merged data for display.

15. The method of claim 14 wherein the merging step includes merging data for one or more of the following with the merged data: tags, alerts, and overlays.

16. A method for locally monitoring a remote service, comprising:
detecting a local communication failure;
checking local resources in response to the communication failure;
checking a remote resource in response to the communication failure; and
attempting to resolve the communication failure based upon the checking steps.

17. The method of claim 16 wherein the checking local resources step includes checking one or more of the following: a local program, a local operating system, and a local power supply.

18. The method of claim 16 wherein the checking the remote resource step includes attempting to contact a remote network site.

19. The method of claim 16, further comprising compiling information related to the failure into a report.

20. A system for providing decision support for automated power trading, comprising:
a plant sub-system for acquiring data from a power generating plant and relating to available power for distribution;
a market sub-system for gathering data from a plurality of sources relating to a market condition for power consumption; and
a central repository sub-system for receiving and storing the acquired data from the plant sub-system and the gathered data from the market sub-system, and for processing the acquired data and the gathered data to provide recommendations concerning distribution of the available power based upon the market condition.

21. The system of claim 20 wherein the plant sub-system includes a module for acquiring process signals for the power generating plants including one or more of the following: a pressure value, a temperature value, a flow value, and a rate value.

22. The system of claim 20 wherein the plant sub-system includes a module for acquiring computed data for the power generating plants including one or more of the following: a heat rate, an efficiency, a machine state, and deviations from normal.

23. The system of claim 20, further including a module for providing for display the acquired data from the power generating plants.

24. The system of claim 20, further including a module for transmitting the acquired data from the power generating plants to a central repository.

25. The system of claim 20 wherein the market sub-system includes a module for obtaining information relating to one or more of the following factors: market demand, market rates, generation requirements, generation forecasts, demand pricing, weather, generation control conditions, base point, fuel pricing, fuel availability, and limits and schedules.

26. The system of claim 20, further including a module for converting the gathered data and the acquired data to a common format and storing the formatted data in a data structure.

27. The system of claim 20 wherein the central repository includes:
a module for retrieving rules relating to power forecasting; and
a module for applying the rules to the acquired data and the gathered data in order to generate the recommendations.

28. The system of claim 20 wherein the central repository includes a module for providing recommendations concerning use of particular financial instruments for distribution of at least a portion of the available power.

29. The system of claim 28 wherein the central repository includes a module for providing the recommendations for use of one or more of the following: forward pricing contracts, options, and collars.

30. The system of claim 20 wherein the central repository includes a module for providing for display, in approximate real-time, a message concerning the recommendations.

31. The system of claim 20, further comprising a map module for merging the data from the power generating plants with map data and transmitting the merged data for display.

32. The system of claim 31 wherein the map module includes a module for merging data for one or more of the following with the merged data: tags, alerts, and overlays.

33. An apparatus for providing geographical references for display of plant data, comprising:
a plant sub-system for acquiring data from a power generating plant and relating to available power for distribution;
a market sub-system for gathering data from a plurality of sources relating to a market condition for power consumption;
a map data source providing map data relating to a geographical location of the power generating plants; and
a central repository for merging the data from the plant sub-system and the market sub-system with the map data and for transmitting the merged data for display.

34. The apparatus of claim 33 wherein the central repository merges data for one or more of the following with the merged data: tags, alerts, and overlays.

35. An apparatus for locally monitoring a remote service, comprising:
a detection module for detecting a local communication failure;
a local resources module for checking local resources in response to the communication failure;
a remote resources module for checking a remote resource in response to the communication failure; and
a resolution module for attempting to resolve the communication failure based upon the checking of the local resources and the remote resource.

36. The apparatus of claim 35 wherein the local resources module includes a module for checking one or more of the following: a local program, a local operating system, and a local power supply.

37. The apparatus of claim 35 wherein the remote resource module includes a module for attempting to contact a remote network site.

38. The apparatus of claim 35, further comprising a module for compiling information related to the failure into a report.

39. A screen for use in electronically displaying information providing geographical references for display of plant data, comprising:
a screen for display on a display device, the screen displaying map data providing geographical references for power generating plants, and displaying a first indication of data from the power generating plants relating to available power for distribution and displaying a second indication of data relating to a market condition for power consumption, both the first and the second indications displayed on the screen as associated with the corresponding geographical references.

40. The screen of claim 39, further providing display of an overlay on the map data.
